(19) United States
(12) Patent Application Publication
(10) Pub. No.: US 2024/0340927 A1
(43) Pub. Date: Oct. 10, 2024

(54) SIDELINK POSITIONING CONFIGURATIONS

(71) Applicant: ZTE Corporation, Shenzhen (CN)

(72) Inventors: Juan LIU, Shenzhen (CN); Chuangxin JIANG, Shenzhen (CN); Mengzhen LI, Shenzhen (CN); Junpeng LOU, Shenzhen (CN); Qi YANG, Shenzhen (CN)

(21) Appl. No.: 18/750,071

(22) Filed: Jun. 21, 2024

Related U.S. Application Data
(63) Continuation of application No. PCT/CN2022/090146, filed on Apr. 29, 2022.

(51) Int. Cl. H04W 72/25; H04L 5/00; H04W 74/08

(52) U.S. Cl. CPC H04W 72/25; H04L 5/0048; H04W 74/08

(57) ABSTRACT

Techniques are described to for communicating reference signals, such as position reference signals between wireless devices. An example wireless communication method includes communicating, by a first wireless communication device, any one or more of: positioning reference signal (PRS) information, a set of information is associated with a first time widow and/or a second time window, or one or more parameters of listen-before-talk (LBT).

### CROSS REFERENCE TO RELATED APPLICATIONS

This patent document is a continuation of and claims benefit of priority to International Patent Application No. PCT/CN2022/090146, filed on Apr. 29, 2022. The entire content of the before-mentioned patent application is incorporated by reference as part of the disclosure of this application.

### TECHNICAL FIELD

This disclosure is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for sidelink positioning, configuring sidelink positioning signals, receiving sidelink positioning signals, transmitting sidelink positioning signals, and/or the like.

A wireless communication method includes communicating, by a first wireless communication device, any one or more of: positioning reference signal (PRS) information, a set of information is associated with a first time widow and/or a second time window, or one or more parameters of listen-before-talk (LBT).

In some embodiments, the communicating is from the first wireless communication device to a second wireless communication device, or from the first wireless communication device to a third wireless communication device through a fourth wireless communication device. In some embodiments, the communicating comprises at least one of: sending, receiving, broadcasting, unicasting, requesting, responding, performing a forward, performing an exchange or groupcasting. In some embodiments, the communicating, by the first wireless communication device, M transmission occasions that indicates a number of transmission occasions in a period or in each period of a plurality of periods, where M is a positive integer, where M is greater than or equal to N, where N is a maximum number of transmission occasions; and communicating, one or more PRS in one or more transmission occasions in accordance with the M transmission occasions. In some embodiments, M represents a total number of transmission occasions.

In some embodiments, M represents a partial number of transmission occasions, and wherein M is P divided by Q, wherein P is a total number of transmission occasions, and Q is a configurable or a default value. In some embodiments, the PRS information, the set of information, the one or more parameters of LBT, M, N, P, or Q are: default values, communicated by or to the first wireless communication device in a control information, a radio resource control (RRC) signaling, a downlink control information (DCI), a sidelink control information (SCI), a medium access control-control elements (MAC CE) information, a non-access stratum (NAS) information, a high layer parameter, or a system information blocks x (SIBx), where x is an integer, or communicated by or to the first wireless communication device in physical sidelink control channel (PSCCH), physical sidelink shared channel (PSSCH), a physical downlink shared channel (PDSCH), a physical uplink shared channel (PUSCH), a Physical Broadcast Channel (PBCH), a Physical Sidelink Feedback Channel (PSFCH), or a Physical Sidelink Broadcast Channel (PSBCH).

In some embodiments, the first wireless communication device transmits the one or more PRS in response to receiving a control information from a second wireless communication device. In some embodiments, the PRS information is informed by a control information. In some embodiments, the second wireless communication device includes a second UE, and/or the control information includes a sidelink control information (SCI). In some embodiments, the control information is in time domain before: one or more locations of one or more PRS transmitted or received by the first wireless communication device, the communicating, or the M transmission occasions. In some embodiments, the one or more locations of the one or more PRS, the communicating, or the M or P transmission occasions are in a window in time domain. In some embodiments, the window is indicated by the control information or is associated with the PRS information. In some embodiments, the one or more parameters of LBT comprise any one or more of: a channel access priority class, a channel access type, a cyclic prefix extension index, or an entry index with combination of at least two of the channel access priority class, the channel access type, the cyclic prefix extension index, or the cyclic prefix extension. In some embodiments, the one or more parameters of LBT is indicated by a control information.

In some embodiments, the one or more parameters of LBT is associated with one or more PRS parameters. In some embodiments, the one or more PRS parameters comprise any one or more of: a PRS period, a PRS duration in time domain, a number of PRS occasion in one period, or a PRS priority. In some embodiments, the control information is associated with one or more occasions for one or more PRS, wherein the control information is associated with the PRS information, or wherein the control information is associated with one or more PRS configurations. In some embodiments, the control information for the LBT includes at least one LBT parameter. In some embodiments, the M transmission occasions, one or more PRS configuration(s) or the PRS information is communicated by of broadcasting, unicasting, or groupcasting. In some embodiments, the channel access priority class is determined according to rule.

In some embodiments, the rule specifies that the channel access priority class for a synchronization signal block (SSB) communicated by the first wireless communication device is set to a smallest channel access priority class value. In some embodiments, the rule specifies that channel access priority class is associated with at least one of: a data priority, a physical sidelink feedback channel (PSFCH), a reference signal, and/or a physical sidelink shared channel (PSSCH). In some embodiments, the one or more parameters of LBT indicates at least one of: Type 1 channel access procedures for PRSs, Type 2A channel access procedures for PRSs, Type 2B channel access procedures for PRSs, Type 2C channel access procedures for PRSs, Type 1 channel access procedures for sidelink signal, Type 2A channel access procedures for sidelink signal, Type 2B channel access procedures for sidelink signal, or Type 2C channel access procedures for sidelink signal. In some embodiments, the one or more parameters of LBT is associate with at least one of: Channel Access Priority Class (CAPC) for uplink (UL), or Channel Access Priority Class (CAPC) for downlink (DL).

In some embodiments, the value of the Channel Access Priority Class of data is smaller or larger than the value of Channel Access Priority Class of the one or more PRS that are configured, transmitted or received. In some embodiments, the PRS information comprises a PRS resource or a parameter of PRS. In some embodiments, a PRS is not transmitted in a gap between two adjacent resource block (RB) set in frequency domain. In some embodiments, a lowest resource block (RB) or resource element (RE) index of a PRS is align or associated with at least one of: a start of each RB set, a start of all RB set, or a start of one certain RB set.

In some embodiments, the second time window is later than the first time window in time domain for a PRS. In some embodiments, the set of information is associated with or includes at least one of: a parameter that is associated with a start of the first time window, a parameter that is associated with an end of the first time window, a parameter that is associated with a start of the second time window, a parameter that is associated with an end of the second time window, a certain time duration in a configuration or a first slot the certain time duration in the configuration, information that includes an allowed one or more synchronization references which are allowed to use the configured resource, information that includes whether a reference signal of a channel is used for RSRP measurement, a counter for resource reselection, a control information of a PRS, a response time or a response time containing early location measurements or an early location estimate, or a PRS priority in a configuration.

In some embodiments, the set of information is associated with at least one of: one or more parameters of data, wherein the one or more parameters of data comprise at least one of: a parameter that is associated with a start of a sensing window, wherein the first time window includes the sensing window, a parameter that is associated with an end of the sensing window, a parameter that is associated with a start of a selection window, wherein the second time window includes the selection window, a parameter that is associated with an end of the selection window, a certain time duration in a configuration or a first slot the certain time duration in the configuration, a parameter that indicates one or more allowed synchronization references which are allowed to use the configured resource, a parameter that indicates whether a reference signal of a channel is used for RSRP measurement, a counter for resource reselection, a control information of data, a response time or a response time containing early location measurements or an early location estimate, or a data priority in a configuration. In some embodiments, the control information of data or PRS is not associated with a PRS in one or more other configurations, the control information of data or PRS is not associated with one or more PRS in different communicated configurations, or the control information of data or PRS is only associated with one or more PRS communicated configurations.

In some embodiments, the control information of PRS, the control information of data or the PRS satisfy at least one of: the control information of PRS is before or after a transmission or reception of one or more PRS in time domain, the control information of PRS is before or after the control information of data in time domain, the control information of data is before or after the transmission or the reception of one or more PRS in time domain, the control information of data is before or after the control information of PRS in time domain, the transmission or the reception of one or more PRS is before or after the control information of data in time domain, the transmission or the reception of one or more PRS is before or after the control information of PRS in time domain, the control information of PRS is not before or after the transmission or the reception of one or more PRS in time domain, the control information of PRS is not before or after the control information of data in time domain, the control information of data is not before or after the transmission or the reception of one or more PRS in time domain, the control information of data is not before or after the control information of PRS in time domain, the transmission or the reception of one or more PRS is not before or after the control information of data in time domain, the transmission or the reception of one or more PRS is not before or after the control information of PRS in time domain, the lowest RB or RE index of the control information of PRS is lower or higher than the lowest RB or RE index of the transmission or the reception of one or more PRS in frequency domain, the lowest RB or RE index of the control information of PRS is lower or higher than the lowest RB or RE index of the control information of data in frequency domain, the lowest RB or RE index of the control information of data is lower or higher than the lowest RB or RE index of the transmission or the reception of one or more PRS in frequency domain, the lowest RB or RE index of the control information of data is lower or higher than the lowest RB or RE index of the control information of PRS in frequency domain, the lowest RB or RE index of the transmission or the reception of one or more PRS is lower or higher than the lowest RB or RE index of the control information of data in frequency domain, the lowest RB or RE index of the transmission or the reception of one or more PRS is lower or higher than the lowest RB or RE index of the control information of PRS in frequency domain, the lowest RB or RE index of the control information of PRS is not lower or higher than the lowest RB or RE index of the transmission or the reception of one or more PRS in frequency domain, the lowest RB or RE index of the control information of PRS is not lower or higher than the lowest RB or RE index of the control information of data in frequency domain, the lowest RB or RE index of the control information of data is not lower or higher than the lowest RB or RE index of the transmission or the reception of one or more PRS in frequency domain, the lowest RB or RE index of the control information of data is not lower or higher than the lowest RB or RE index of the control information of PRS in frequency domain, the lowest RB or RE index of the transmission or the reception of one or more PRS is not lower or higher than the lowest RB or RE index of the control information of data in frequency domain, or the lowest RB or RE index of the transmission or the reception of one or more PRS is not lower or higher than the lowest RB or RE index of the control information of PRS in frequency domain.

In some embodiments, the configuration comprises at least one of a resource pool, a carrier frequency, a bandwidth part (BWP), a RB set or a subchannel. In some embodiments, the parameter is associated with an end of the second time window that includes a transmission or reception of one or more PRS satisfies at least one of: the parameter that is associated with an end of the second time window is value, the parameter that is associated with an end of the second time window is not related to PRS priority, the parameter that is associated with an end of the second time window is related to PRS priority, the parameter that is associated with an end of the second time window is related to response time a response time containing early location measurements or an early location estimate, the parameter that is associated with an end of the second time window is smaller or larger than response time a response time containing early location measurements or an early location estimate, the parameter that is associated with an end of the second time window is related to packet delay budget, or the parameter that is associated with an end of the second time window is before or after the parameter that is associated with an end of the second time window in time domain. In some embodiments, the parameter associated with a start or end of the first time window, or the parameter associated with a start or end of the second time window of the PRS satisfies at least one of: the parameter that is associated with the start of the first time window of the PRS is before or after the parameter that is associated with the start of the sensing window of the data, the parameter that is associated with the end of the first time window of the PRS is before or after the parameter that is associated with the end of the sensing of the data, the parameter that is associated with the start of the second time window of the PRS is before or after the parameter that is associated with the start of the selection window of the data, the parameter that is associated with the end of the second time window of the PRS is before or after the parameter that is associated with the end of the selection window of the data, an offset between the parameter that is associated with the start of the first time window of the PRS and the parameter that is associated with the start of the sensing window of the data, an offset between the parameter that is associated with the end of the first time window of the PRS and the parameter that is associated with the end of the sensing of the data, an offset between the parameter that is associated with the start of the second time window of the PRS and the parameter that is associated with the start of the selection window of the data, an offset between the parameter that is associated with the end of the second time window of the PRS and the parameter that is associated with the end of the selection window of the data, the parameter that is associated with the start of the first time window of the PRS is N time or N times of the parameter that is associated with the start of the sensing window of the data, the parameter that is associated with the end of the first time window of the PRS is N time or N times of the parameter that is associated with the end of the sensing of the data, the parameter that is associated with the start of the second time window of the PRS is N time or N times of the parameter that is associated with the start of the selection window of the data, the parameter that is associated with the end of the second time window of the PRS is N time or N times of the parameter that is associated with an end of the selection window of the data, or the parameter that is associated with the counter for resource reselection of the PRS is N time or N times of the parameter that is associated with the counter for resource reselection of the data, where N is a positive integer.

In some embodiments, the set of information includes one or more allowed synchronization references which are allowed to use the configured resource is associated with at least one of: a parameter in associated with data configuration, a parameter associated with a PRS configuration. In some embodiments, the set of information includes whether a reference signal of a channel is used for RSRP measurement that comprises at least one of: a reference signal of PSSCH, a reference signal of PSCCH, a reference signal which is associated with the PRS information. In some embodiments, the wireless communication device comprises a user equipment (UE), a network node, a base station, a local sever, a Transmission Reception Point (TRP), or a Location Management Function (LMF) device. In some embodiments, the gap is associated with UE capability. In some embodiments, there is no gap, which is associated with UE capability. In some embodiments, the gap equals to zero. In some embodiments, the control information of data comprises a parameter which indicates whether a PRS configuration is active or deactivate.

In some embodiments, the PRS information does not comprise muting pattern information in operation with shared spectrum channel access. In some embodiments, the set of information and one or more parameters of data is independent, or the set of information and one or more parameters of data is configured or pre-configured. In some embodiments, a relationship of the certain time duration in a configuration or a first slot the certain time duration in the configuration in the set of information and one or more parameters of data is one of: the same, the certain time duration in a configuration or a first slot the certain time duration in the configuration in the set of information is before or after the certain time duration in a configuration or a first slot the certain time duration in the configuration in one or more parameters of data, or the certain time duration in a configuration or a first slot the certain time duration in the configuration in the set of information is not before or after the certain time duration in a configuration or a first slot the certain time duration in the configuration in one or more parameters of data. In some embodiments, the first time window includes a sensing window, and/or the second time window includes a selection window.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIGS. 1A-ID provide exemplary diagrams that relate to resources used by various signals that may be transmitted in accordance with various embodiments described herein.

FIGS. 2A-2B provide exemplary diagrams that illustrate sets of control information that may be used for sidelink positioning in accordance with various embodiments described herein.

FIG. 3 provides a diagram that illustrates different time windows in which signals and/or data may be received by a communications device for sidelink positioning.

FIG. 4 shows an exemplary flowchart for communicating information by a first wireless communication device.

FIG. 5 shows an exemplary block diagram of a hardware platform that may be a part of a network device or a communication device.

FIG. 6 shows an example of wireless communication including a base station (BS) and user equipment (UE) based on some implementations of the disclosed technology.

FIGS. 7A-7D provide example diagrams that relate to resources used by various signals that may be transmitted in accordance with various embodiments.

FIGS. 8A-8D provide example diagrams that relate to resources used by various signals that may be transmitted in accordance with various embodiments.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Transmission Opportunities for Unlicensed Sidelink Positioning

A transmission occasion number may be defined by M and a maximum number of transmission occasions may be defined by N, where M≥N and M, N are integers. In some example embodiments, the transmission occasion number M may represent a total transmission occasion number in one and/or each period (e.g., a radio frame, a specific time duration, and/or the like). In some example embodiments, the transmission occasion number M may represent a partial transmission occasion number in one and/or each period, while P may define a total transmission occasion number in one and/or each period such that P=Q*M. That is, in some example embodiments,

$$Q = ⌊ \frac{P}{M} ⌋ or Q = ⌈ \frac{P}{M} ⌉ .$$

In various embodiments, a sidelink control information (SCI) trigger the positioning reference signal (PRS) transmission, a PRS period, a PRS window. In various embodiments, the SCI is before the triggered resource. In various embodiments, each of at least one of M, N, or Q may be configured using any one or more of the following: default values, SCI, radio resource control (RRC), downlink control information (DCI), medium access control-control elements (MAC CE), non-access stratum (NAS), high layer parameters, or system information blocks x (SIBx), where x is an integer.

### II. Relationships of PRS Muting Pattern Information and Unlicensed Sidelink Positioning Transmission Opportunities

According to various embodiments, muting pattern information are not configured or enabled for sidelink positioning, as listen-before-talk (LBT) procedures and muting pattern information are directed to interference cancellation. In some example embodiments, at least muting pattern information can be configured/enabled, extend a continuous repetition number or parameter M. For example, a continuous repetition number may be 1, 2, 4, 8, and/or other suitable integers. In some example embodiments, at least muting pattern information can be configured or enabled using a bit map manner across different repetitions. For example, for a given repetition, if the bit map is 1 and a listen-before-talk (LBT) procedure results in failure, a LBT procedure may be performed for a repetition with a bit map of 0.

### III. Indication of LBT in Sidelink Signals

In various embodiments, one or more PRS LBT parameters are indicated in the first or second region. The first and second regions may include SCI information. For example, in one region, SCI can be carried on PSCCH is a 1st-stage SCI, which transports sidelink scheduling information, and in another region the SCI carried on PSSCH is a 2nd-stage SCI, which transports sidelink scheduling information.

In various embodiments, LBT parameters for a sidelink signal may be pre-configured. In various embodiments, LBT parameter(s) is associated with PRS parameter(s). In various embodiments, PRS parameter(s) include at least one of: PRS time duration, the number PRS occasion(s)/repetitions in one PRS, or a PRS priority. In various embodiments, one or more LBT parameter(s) for the SCI is related to the PRS parameter. In various embodiments, one SCI is related to one or more PRS configuration(s). In various embodiments, SCI, PRS configuration or PRS may use one of: broadcasting, unicasting, groupcasting. In various embodiments, the LBT parameters may be generated based on components of the sidelink signals, based on a presence of data in certain positions or slots of the sidelink signal, and/or the like. In various embodiments, a sidelink slot may be one or more subframes, one or more portions within a subframe (e.g., one or more half-frames), etc. For example, in some example embodiments, a LBT priority parameter for a sidelink synchronization signal block (SL-SSB) may be set to the highest priority value (e.g., p=1) if there is no data in the sidelink slot of the SL-SSB. In some examples, if there is data in the sidelink slot, the LBT priority parameter may be determined based on a LBT priority with data quality of service (QOS) and/or a physical sidelink shared channel (PSSCH). In some examples, if there is data and a physical sidelink feedback channel (PSFCH), the LBT priority parameter may be determined based on a LBT priority associated with the PSFCH. In some examples, if there is data, a PRS, and/or a PSFCH in a sidelink slot or a sidelink specify time duration, the LBT priority associated with at least one of (or any one or more of) the data, the PRS, and/or the PSFCH may be used for the LBT priority parameter. In one non-limiting illustrative example, the sidelink slot may include a PRS associated with a high LBT priority and data associated with a low LBT priority, and the high LBT priority of the PRS may be used for the LBT priority parameter over the low LBT priority of the data. In another non-limiting illustrative example, the sidelink slot may include data associated with high LBT priority (e.g., voice data) and a PRS associated with a low LBT priority, and the LBT priority parameter may be based on the high LBT priority of the data. In various embodiments, only Type 1 LBT parameters are used in sidelink positioning. In various embodiments, the specify time duration is a continuous logical resource in a sidelink resource configuration.

### IV. LBT Priority and PRS Priority

In various embodiments, the higher the PRS priority value is, the higher the LBT priority parameter is. Table 1 illustrates an example relationship between PRS priority values and LBT priority parameters, according to an example embodiment.

TABLE 1

| PRS priority value | LBT priority value |
|---|---|
| 1 | P = 1 |
| 2 | |
| 3 | P = 2 |
| 4 | |
| 5 | P = 3 |
| 6 | |
| 7 | P = 4 |
| 8 | |

In various embodiments, a parameter is used for the association of PRS priority and LBT priority (CAPC: channel access priority class).

In various embodiments, a sidelink PRS uses a parameter associated with uplink LBT or a parameter associated with downlink LBT.

For a communication device, if the LBT priority for sidelink data is higher than that for sidelink PRS, the LBT procedure for the sidelink data begins before/earlier than the LBT procedure for the sidelink PRS, in various embodiments. Similarly, if the LBT priority for sidelink PRS is higher than that for sidelink data, the LBT procedure for the sidelink PRS begins before/earlier than the LBT procedure for the sidelink data.

In some example scenarios, the LBT priority for sidelink data may be the same as sidelink PRS, and in some example embodiments, the LBT procedure for the sidelink data begins before/earlier than the LBT procedure for the sidelink PRS. In other example embodiments, the LBT procedure for the sidelink PRS begins before/earlier than the LBT procedure for the sidelink data, in such example scenarios.

In various embodiments, a first sidelink PRS (PRS1) and a second sidelink PRS (PRS2) may be involved, and if the LBT priority for the first sidelink PRS is higher than that for the second sidelink PRS, the LBT procedure for the first sidelink PRS begins before/earlier than the LBT procedure for the second sidelink PRS. For a communication device, the LBT priority for the first sidelink PRS and the LBT priority for the second sidelink PRS may be the same, and the LBT is associated with the timing of the received PRS indication information. In some embodiments, the LBT may refers to the LBT priority for both the sidelink PRS1 and the sidelink PRS2.

In various embodiments, the PRS LBT may be configured or may be by default.

V. PRS Transmission versus Resource Block (RB) Sets

In various embodiments, the lowest resource block (RB) or resource element (RE) index of a PRS is aligned/associated with the start of each RB set. In various embodiments, the lowest RB/RE index of a PRS is aligned/associated with the start of all RB sets. In various embodiments, the lowest RB/RE index is aligned/associated with the start of one certain RB set.

In various embodiments, the PRS is not transmitted in gaps between RB sets in the frequency domain.

In various embodiments, a gap between RB sets is associated the PRS parameter or other parameter (e.g., PRS bandwidth/PRS frequency domain occupancy length, UE capability).

VI. Sidelink Data Transmission versus RB Sets

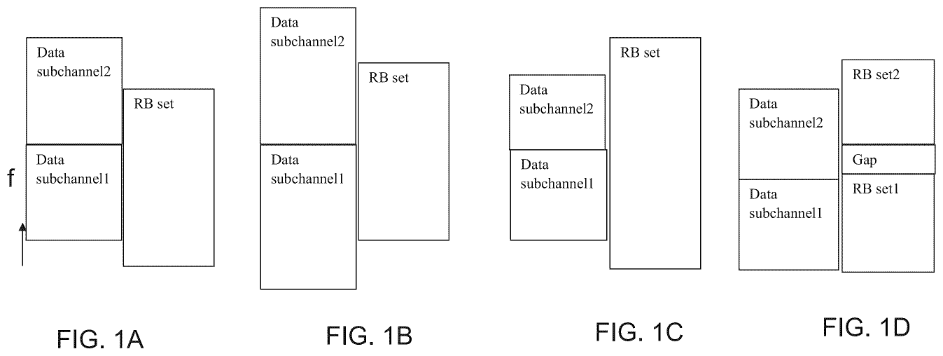

FIGS. 1A-1D provide diagrams that illustrate data sub-channels and RB sets. In various embodiments, sidelink data may be transmitted or be valid in sub-channels that not overlap an RB set. For example, sidelink data in “data subchannel1” shown in FIG. 1A, “data subchannel1” shown in FIG. 1C, and “data subchannel2” shown in FIG. 1C may be transmitted or be valid.

In various embodiments, sidelink data may not be valid in sub-channels which are not overlapped or partially overlap the RB set. For example, sidelink data in “data subchannel2” shown in FIG. 1A, “data subchannel1” shown in FIG. 1B, and “data subchannel2” shown in FIG. 1B may not be valid.

In various embodiments, sidelink data may not be valid in sub-channels in which a control signal in the frequency domain is not overlapped with or partially overlaps the RB set. For example, sidelink data in “data subchannel2” shown in FIG. 1A, “data subchannel1” shown in FIG. 1B, and “data subchannel2” shown in FIG. 1B may not be valid.

In various embodiments, sidelink data is not transmitted in gaps between RB sets in the frequency domain. FIG. 1D illustrates a gap that is between two RB sets and in which sidelink data is not transmitted. “data subchannel1” shown in FIG. 1D may be valid. “data subchannel2” shown in FIG. 1D may not be valid.

In various embodiments, sidelink data is transmitted in gaps between RB sets in the frequency domain. FIG. 1D illustrates a gap that is between two RB sets and in which sidelink data is transmitted “data subchannel1” and “data subchannel2” shown in FIG. 1D may not be valid.

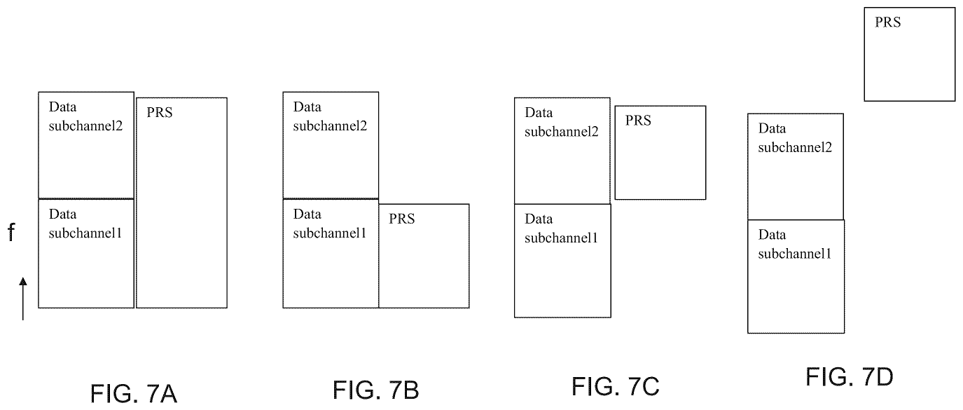

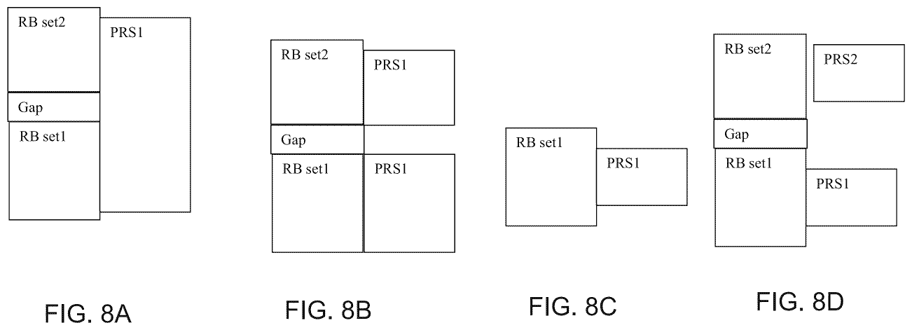

FIGS. 7A-7D and 8A-8D provide additional example diagrams that relate to resources used by various signals that may be transmitted in accordance with various embodiments.

VII. Sl-RS-ForSensing Configuration in Sidelink (if PRS introduced)

sl-RS-ForSensing may be selected for different resource configurations of sidelink data and PRS, in which at least one of resource pool, bandwidth parts (BWP), carrier frequency, or sub-channels are configured. In various embodiments, a sl-RS-ForSensing parameter is selected for each different resource configuration. According to some example embodiments, for a sidelink control information (SCI) of independent configuration for PRS, the sl-RS-ForSensing for the PRS is configured with the demodulation reference signal (DMRS) of the PRS physical sidelink control channel (PSCCH). According to some example embodiments, for an independent PRS configuration which is associated with one or more data configurations, a SCI is included in the one or more data configurations, and the sl-RS-ForSensing parameter is configured as at least one of the PSCCH DM RS, PSCCH DM RS, or PSCCH DM RS of PRS. According to some example embodiments, if the PRS configuration(s) and the data configuration(s) are in the same configuration, a SCI is included in the configuration(s), and the sl-RS-ForSensing parameter is configured as at least one of PSCCH DM RS, PSCCH DM RS, or PSCCH DM RS of PRS.

### VIII. Sidelink PRS Allowed

In various embodiments, if an independent PRS configuration is introduced, a SL-SyncAllowed parameter is included in the independent PRS configuration. In various embodiments, this parameter in data configuration is associated with or used in the PRS configuration, or the parameter is not included in the PRS configuration. In various embodiments, a PRS configuration list is configured, and all configuration parameters may be reused in accordance with 3rd Generation Partnership Project (3GPP) Rel. 16/17. PRS parameters that should be configured may include comb size, PRS period, etc.

### IX. Sidelink PRS Sensing/Selection Window Parameters

In various embodiments, sidelink data and sidelink PRSs may use the same or independent resource configurations. In various embodiments, sidelink data and sidelink PRSs may use the same or different control information (e.g., one set of SCI, different SCIs). Alternatively, control information for sidelink PRS may be included in the PSSCH.

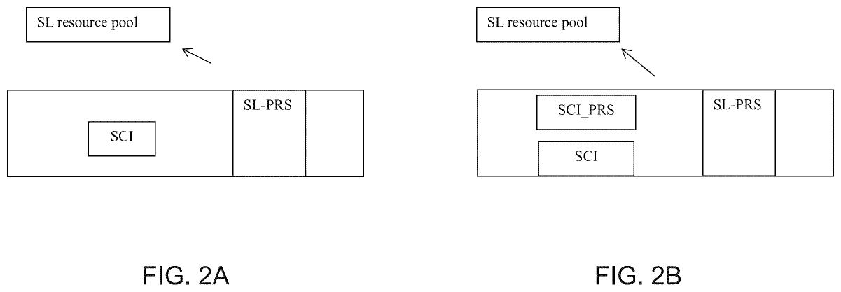

In FIG. 2A, a sidelink PRS (“SL-PRS”) uses a general or non-positioning-specific SCI, according to an example embodiment. FIG. 2B illustrates another example embodiment, in which a positioning-specific SCI (“SCI_PRS”) is configured and used for the sidelink PRS, with the positioning-specific SCI being independent from the general SCI.

### T0:

sl-Sensing Window-r16 ENUMERATED {ms100, ms1100}
sl-Sensing Window
Parameter that indicates the start of the sensing window.

### Tproc0:

TABLE 2
T_{proc, 0}^{SL} depending on sub-carrier spacing

| μ_{SL} | T_{proc, 0}^{SL} [slots] |
|---|---|
| 0 | 1 |
| 1 | 1 |
| 2 | 2 |
| 3 | 4 |

### T1:

0<=T1<=T_{proc1}^{SL}

TABLE 3
T_{proc, 1}^{SL} depending on sub-carrier spacing

| μ_{SL} | T_{proc, 1}^{SL} [slots] |
|---|---|
| 0 | 3 |
| 1 | 5 |
| 2 | 9 |
| 3 | 17 |

### T2:

### T₂ₘᵢₙ<=T2<=Packet Delay Budget

### T₂ₘᵢₙ:

T₂ₘᵢₙ can be the same as the parameter sl-Selection Window List.
Sl-Selection Window List parameter that determines the end of the selection window in the resource selection for a TB with respect to priority indicated in SCI. Value n1 corresponds to 1*2^{μ}, value n5 corresponds to 5*2^{μ}, and so on, where μ=0,1,2,3 refers to sub-carrier spacings (SCS) 15,30,60,120 kHz respectively.

| | |
|---|---|
| SL-UE-SelectedConfigRP-r16 ::= | SEQUENCE { |

...

| | |
|---|---|
| sl-SelectionWindowList-r16 | SL-SelectionWindowList-r16 |

OPTIONAL, -- Need M

| | |
|---|---|
| SL-SelectionWindowList-r16 ::= | SEQUENCE (SIZE (8)) OF SL-SelectionWindowConfig- |

r16

| | |
|---|---|
| SL-SelectionWindowConfig-r16 ::= | SEQUENCE { |

sl-Priority-r16 INTEGER (1..8),

| | |
|---|---|
| sl-SelectionWindow-r16 | ENUMERATED {n1, n5, n10, n20} |

}

In accordance with the above, in some examples, the T2 parameter represents the end of a selection window. As shown, the T2 parameter may take values that are greater than or equal to the T₂ₘᵢₙ parameter and that are less than or equal to a packet delay budget, in various embodiments.

In accordance with the above, in some examples, the sl-Selection WindowList parameter (e.g., sl-SelectionWindowList-r16) is indicated to and received by a UE that also receives the sidelink PRSs. In various embodiments, the UE receives one or more sl-Selection WindowList parameters earlier in time to receiving one or more sidelink PRSs.

In the above example configuration of the sl-Selection WindowList parameter (e.g., sl-SelectionWindowList-r16), the sl-Priority-r16 parameter represents a priority of data.

In various embodiments, new parameters (e.g., T₀, T₁, T₂, T₂ₘᵢₙ, T_{proc,1}) can be configured or preconfigured for sidelink PRS (SL-PRS). In various embodiments, all new parameters (e.g., T₀, T₁, T₂, T₂ₘᵢₙ, T_{proc,1}) are not associated with the parameters for sidelink data (e.g., T₀, T₁, T₂, T₂ₘᵢₙ, T_{proc0}, T_{proc1}). In various embodiments, all new parameters (e.g., T₀, T₁, T₂, T₂ₘᵢₙ, T_{proc,1}) are associated with the parameters for sidelink data (e.g., T₀, T₁, T₂, T₂ₘᵢₙ, T_{proc0}, T_{proc1}). In various embodiments, at least some of the new parameters (e.g., T₀, T₁, T₂, T₂ₘᵢₙ, T_{proc,1}) are associated with the parameters for sidelink data (e.g., T₀, T₁, T₂, T₂ₘᵢₙ, T_{proc0}, T_{proc1}).

In various embodiments, some offset value for SL-PRS, which is compared to data parameters (e.g., T₀, T₁, T₂, T₂ₘᵢₙ, T_{proc0}, T_{proc1}) are (pre) configured.

The value of the offset is related with the priority of SL-PRS or data.

The value of T₂ₘᵢₙ for data may be related to the priority of data. If there is no priority value for data, a fixed T₂ₘᵢₙ for SL-PRS is configured. For example, the value of T₂ₘᵢₙ can be sl-Selection Window-r16 (as shown above), and the priority of data can be sl-Priority-r16 (as shown above).

The value of T₂ₘᵢₙ for SL-PRS may be related to the priority of PRS. The PRS may have the same configuration as data.

There is no packet delay budget for PRS, so the T₂ value for PRS is fixed. For example, T₂ may be configured to equal T₂ₘᵢₙ, where Tₘᵢₙ is associated with the PRS SCS.

The configuration or resource configuration is the carrier frequency, bandwidth part, resource pool, or subchannels.

At least some of the PRS parameters are indicated through using one of the following ways: SCI, PSCCH, PSSCH, RRC, DCI, or high layer parameter.

The T_{proc0} and T₁ are associated with the PRS SCS.

### X. Sidelink PRS Time or Frequency Position

Information for PRS (e.g., whether sidelink control information for the PRS (SCI_PRS) exists or not, whether the PRS is active or not) is included in a SCI for sidelink data. With respect to frequency, the frequency information (e.g., the lowest RB/RE index) of SCI for data/PRS is not lower/higher than the frequency information (e.g., the lowest RB/RE index) of PRS/SCI for sidelink PRS, in various embodiments. With respect to time, the time information (e.g., the starting time) of SCI for data/PRS is not earlier/later than the time information (e.g., the starting time) of PRS/SCI for sidelink PRS.

Alternatively, the SCI for PRS is not after the PRS.

Alternatively, the PRS or SCI for PRS is continuous in time and frequency domain.

Alternatively, the PRS or SCI for PRS is configured periodically.

### XI. Related Issues for Sidelink Independent Windows

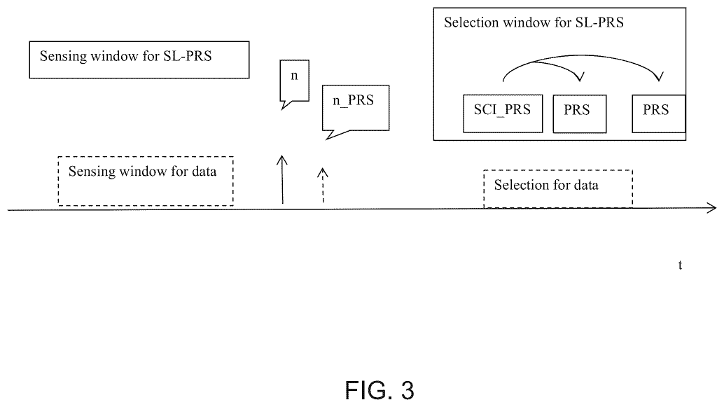

FIG. 3 provides a diagram that includes a first time window (e.g., a sensing window) and a second time window (e.g., a selection window) for SL_PRS and that demonstrates various embodiments. FIG. 3 further includes a first time window (e.g., a sensing window) and a second time window (e.g., a selection window) for sidelink data. As shown in FIG. 3, the sensing window for SL_PRS may be independent from (e.g., with respect to frequency, with respect to time) the sensing window for sidelink data, and the selection window for SL_PRS may be independent from (e.g., with respect to frequency, with respect to time) the selection window for sidelink data. For example, in some example scenarios, the sensing window for SL_PRS may occur earlier in time than the sensing window for sidelink data or it may occur later in time than the sensing window for sidelink data. For example, in some example scenarios, the selection window for SL_PRS may occur earlier in time than the selection window for sidelink data or it may occur later in time than the selection window for sidelink data.

Within a sensing window for SL_PRS and/or a sensing for sidelink data, a UE may receive and detect a sensing result. In various embodiments, the UE receives and detects the sensing result based on system information (SI) that it may receive originating from another wireless communication node/device (e.g., another UE, a base station). In some example scenarios, the UE that may receive and detect the sensing result in a sensing window (e.g., a sensing window for SL_PRS, a sensing window for data) receives the SI from a second UE to which the sidelink PRSs are transmitted. In various embodiments, the SI comprises parameters associated with (e.g., defining) a second time window (e.g., a selection window) within which the UE may transmit one or more sidelink PRSs. For example, the SI may include at least one of the parameters discussed in section IX, in various embodiments.

In FIG. 3, n refer to a certain time duration in a configuration or a first slot after the certain time duration in the configuration of data; and n_PRS refer to a certain time duration in a configuration or a first slot after the certain time duration in the configuration of data.

FIG. 3 further illustrates transmission of one or more sidelink PRSs to a second UE, and in various embodiments, the transmission of the one or more sidelink PRSs occurs later in time and based on the receiving and detection of a sensing result during a sensing window for SL_PRS. In various embodiments, the transmission of the one or more sidelink PRSs occurs during a second time window (e.g., the selection window) that is later in time than the sensing window. In various embodiments, the transmission of the one or more sidelink PRSs is based on SCI_PRS, or control information associated with SL_PRS, as illustrated in FIG. 3. For example, the SCI_PRS may specify the time (e.g., within the selection window) at which the one or more sidelink PRSs are transmitted. In some examples, the SCI_PRS may specify additional aspects of the sidelink PRS transmission(s), such as specific resource blocks for the sidelink PRSs.

In various embodiments, the SCI_PRS may be received by the UE periodically from another wireless communication device/node (e.g., a base station, another UE). In various embodiments, the UE transmits the one or more sidelink PRSs to a second UE from which the UE received the SI and/or the SCI_PRS.

In various embodiments, a selection window for SL-PRS is associated with at least one of: a PRS period for a transmitting user equipment (TX UE), a PRS priority for the TX UE.

In various embodiments, the select resource in the selection window is based on the resource of the SCI/control information of SL_PRS in the sensing window for SL-PRS.

In various embodiments, the select resource in the selection window is not related to the SCI/control information of sidelink data in the sensing window for data;

In various embodiments, the sensing window for SL-PRS is associated with at least one of: one or more PRS periods for a receiving user equipment (RX UE), one or more PRS priority for the RX UE, a PRS SCS for the RS UE, the PRS time duration, or the number of the PRS configurations.

In various embodiments, the sensing/selection window for sidelink data and the sensing/selection window for SL-PRS are compared. For example, if the sensing/selection window for data is lower than sensing/selection window for SL-PRS, the start time of the sensing/selection window for SL-PRS is later/earlier/before than the sensing/selection window for data, or the sensing/selection window for SL-PRS ending time is later/earlier/before the sensing/selection window for data.

### XII. Sidelink Standalone PRS

At least one of the following is indicated/configured: the configuration of standalone PRS, the PRS is indicated by SCI, or the data indicated by SCI.

The configuration, or the deactivation/activation Standalone PRS using control information using, for example:
The parameter(s) of the configuration of Standalone PRS include at least one of the following: independence resource configuration (BWP/carrier frequency/resource pool/subchannel), the configuration of time/frequency domain (e.g.: pattern), period, Comb size, point A, the time duration of PRS.
using the high layer parameter to configuration the PRS time/frequency resource, or deactivation/activation Standalone PRS using control information.

PRS configuration is indicated by SCI, the configuration include the time/frequency resource. Using sensing, selection, re-selection, pre-emption to determine the Tx resource.

Data configuration is indicated by SCI.

The priority of Standalone PRS, PRS configuration is indicated by SCI or Data configuration is indicated by SCI.
If the priority is indicated by Standalone PRS or the SCI of PRS configuration. Using the priority value determine the priority;
If the priority is indicated the SCI of PRS configuration, Standalone PRS have the lowest/highest priority;
There is no priority indication for Standalone PRS or the SCI of PRS configuration; Standalone PRS have the lowest/highest priority; the SCI of PRS configuration the lowest/highest priority, the SCI of PRS configuration have the same priority as the associated data configuration. E.g.: Standalone PRS priority >Data configuration priority; Standalone PRS priority <Data configuration priority; Standalone PRS priority >SCI of PRS configuration priority; Standalone PRS priority <SCI of PRS configuration priority;
Data configuration priority>SCI of PRS configuration priority; Data configuration priority<SCI of PRS configuration priority.

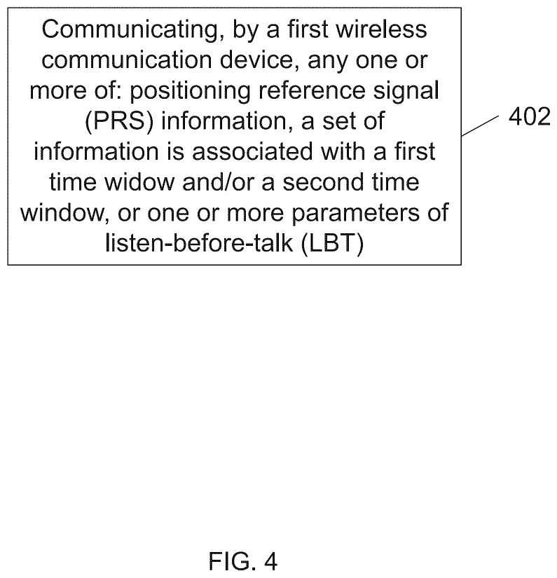

FIG. 4 shows an exemplary flowchart for communicating information by a first wireless communication device. Operation 402 includes communicating, by a first wireless communication device, any one or more of: positioning reference signal (PRS) information, a set of information is associated with a first time widow and/or a second time window, or one or more parameters of listen-before-talk (LBT).

In some embodiments, the communicating is from the first wireless communication device to a second wireless communication device, or from the first wireless communication device to a third wireless communication device through a fourth wireless communication device. In some embodiments, the communicating comprises at least one of: sending, receiving, broadcasting, unicasting, requesting, responding, performing a forward, performing an exchange or groupcasting. In some embodiments, the communicating, by the first wireless communication device, M transmission occasions that indicates a number of transmission occasions in a period or in each period of a plurality of periods, where M is a positive integer, where M is greater than or equal to N, where N is a maximum number of transmission occasions; and communicating, one or more PRS in one or more transmission occasions in accordance with the M transmission occasions. In some embodiments, M represents a total number of transmission occasions.

In some embodiments, M represents a partial number of transmission occasions, and wherein M is P divided by Q, wherein P is a total number of transmission occasions, and Q is a configurable or a default value. In some embodiments, the PRS information, the set of information, the one or more parameters of LBT, M, N, P, or Q are: default values, communicated by or to the first wireless communication device in a control information, a radio resource control (RRC) signaling, a downlink control information (DCI), a sidelink control information (SCI), a medium access control-control elements (MAC CE) information, a non-access stratum (NAS) information, a high layer parameter, or a system information blocks x (SIBx), where x is an integer, or communicated by or to the first wireless communication device in physical sidelink control channel (PSCCH), physical sidelink shared channel (PSSCH), a physical downlink shared channel (PDSCH), a physical uplink shared channel (PUSCH), a Physical Broadcast Channel (PBCH), a Physical Sidelink Feedback Channel (PSFCH), or a Physical Sidelink Broadcast Channel (PSBCH).

In some embodiments, the first wireless communication device transmits the one or more PRS in response to receiving a control information from a second wireless communication device. In some embodiments, the PRS information is informed by a control information. In some embodiments, the second wireless communication device includes a second UE, and/or the control information includes a sidelink control information (SCI). In some embodiments, the control information is in time domain before: one or more locations of one or more PRS transmitted or received by the first wireless communication device, the communicating, or the M transmission occasions. In some embodiments, the one or more locations of the one or more PRS, the communicating, or the M or P transmission occasions are in a window in time domain. In some embodiments, the window is indicated by the control information or is associated with the PRS information. In some embodiments, the one or more parameters of LBT comprise any one or more of: a channel access priority class, a channel access type, a cyclic prefix extension index, or an entry index with combination of at least two of the channel access priority class, the channel access type, the cyclic prefix extension index, or the cyclic prefix extension. In some embodiments, the one or more parameters of LBT is indicated by a control information.

In some embodiments, the one or more parameters of LBT is associated with one or more PRS parameters. In some embodiments, the one or more PRS parameters comprise any one or more of: a PRS period, a PRS duration in time domain, a number of PRS occasion in one period, or a PRS priority. In some embodiments, the control information is associated with one or more occasions for one or more PRS, wherein the control information is associated with the PRS information, or wherein the control information is associated with one or more PRS configurations. In some embodiments, the control information for the LBT includes at least one LBT parameter. In some embodiments, the M transmission occasions, one or more PRS configuration(s) or the PRS information is communicated by of broadcasting, unicasting, or groupcasting. In some embodiments, the channel access priority class is determined according to rule.

In some embodiments, the rule specifies that the channel access priority class for a synchronization signal block (SSB) communicated by the first wireless communication device is set to a smallest channel access priority class value. In some embodiments, the rule specifies that channel access priority class is associated with at least one of: a data priority, a physical sidelink feedback channel (PSFCH), a reference signal, and/or a physical sidelink shared channel (PSSCH). In some embodiments, the one or more parameters of LBT indicates at least one of: Type 1 channel access procedures for PRSs, Type 2A channel access procedures for PRSs, Type 2B channel access procedures for PRSs, Type 2C channel access procedures for PRSs, Type 1 channel access procedures for sidelink signal, Type 2A channel access procedures for sidelink signal, Type 2B channel access procedures for sidelink signal, or Type 2C channel access procedures for sidelink signal. In some embodiments, the one or more parameters of LBT is associate with at least one of: Channel Access Priority Class (CAPC) for uplink (UL), or Channel Access Priority Class (CAPC) for downlink (DL).

In some embodiments, the value of the Channel Access Priority Class of data is smaller or larger than the value of Channel Access Priority Class of the one or more PRS that are configured, transmitted or received. In some embodiments, the PRS information comprises a PRS resource or a parameter of PRS. In some embodiments, a PRS is not transmitted in a gap between two adjacent resource block (RB) set in frequency domain. In some embodiments, a lowest resource block (RB) or resource element (RE) index of a PRS is align or associated with at least one of: a start of each RB set, a start of all RB set, or a start of one certain RB set.

In some embodiments, the second time window is later than the first time window in time domain for a PRS. In some embodiments, the set of information is associated with or includes at least one of: a parameter that is associated with a start of the first time window, a parameter that is associated with an end of the first time window, a parameter that is associated with a start of the second time window, a parameter that is associated with an end of the second time window, a certain time duration in a configuration or a first slot the certain time duration in the configuration, information that includes an allowed one or more synchronization references which are allowed to use the configured resource, information that includes whether a reference signal of a channel is used for RSRP measurement, a counter for resource reselection, a control information of a PRS, a response time or a response time containing early location measurements or an early location estimate, or a PRS priority in a configuration.

In some embodiments, the set of information is associated with at least one of: one or more parameters of data, wherein the one or more parameters of data comprise at least one of: a parameter that is associated with a start of a sensing window, wherein the first time window includes the sensing window, a parameter that is associated with an end of the sensing window, a parameter that is associated with a start of a selection window, wherein the second time window includes the selection window, a parameter that is associated with an end of the selection window, a certain time duration in a configuration or a first slot the certain time duration in the configuration, a parameter that indicates one or more allowed synchronization references which are allowed to use the configured resource, a parameter that indicates whether a reference signal of a channel is used for RSRP measurement, a counter for resource reselection, a control information of data, a response time or a response time containing early location measurements or an early location estimate, or a data priority in a configuration. In some embodiments, the control information of data or PRS is not associated with a PRS in one or more other configurations, the control information of data or PRS is not associated with one or more PRS in different communicated configurations, or the control information of data or PRS is only associated with one or more PRS communicated configurations.

In some embodiments, the control information of PRS, the control information of data or the PRS satisfy at least one of: the control information of PRS is before or after a transmission or reception of one or more PRS in time domain, the control information of PRS is before or after the control information of data in time domain, the control information of data is before or after the transmission or the reception of one or more PRS in time domain, the control information of data is before or after the control information of PRS in time domain, the transmission or the reception of one or more PRS is before or after the control information of data in time domain, the transmission or the reception of one or more PRS is before or after the control information of PRS in time domain, the control information of PRS is not before or after the transmission or the reception of one or more PRS in time domain, the control information of PRS is not before or after the control information of data in time domain, the control information of data is not before or after the transmission or the reception of one or more PRS in time domain, the control information of data is not before or after the control information of PRS in time domain, the transmission or the reception of one or more PRS is not before or after the control information of data in time domain, the transmission or the reception of one or more PRS is not before or after the control information of PRS in time domain, the lowest RB or RE index of the control information of PRS is lower or higher than the lowest RB or RE index of the transmission or the reception of one or more PRS in frequency domain, the lowest RB or RE index of the control information of PRS is lower or higher than the lowest RB or RE index of the control information of data in frequency domain, the lowest RB or RE index of the control information of data is lower or higher than the lowest RB or RE index of the transmission or the reception of one or more PRS in frequency domain, the lowest RB or RE index of the control information of data is lower or higher than the lowest RB or RE index of the control information of PRS in frequency domain, the lowest RB or RE index of the transmission or the reception of one or more PRS is lower or higher than the lowest RB or RE index of the control information of data in frequency domain, the lowest RB or RE index of the transmission or the reception of one or more PRS is lower or higher than the lowest RB or RE index of the control information of PRS in frequency domain, the lowest RB or RE index of the control information of PRS is not lower or higher than the lowest RB or RE index of the transmission or the reception of one or more PRS in frequency domain, the lowest RB or RE index of the control information of PRS is not lower or higher than the lowest RB or RE index of the control information of data in frequency domain, the lowest RB or RE index of the control information of data is not lower or higher than the lowest RB or RE index of the transmission or the reception of one or more PRS in frequency domain, the lowest RB or RE index of the control information of data is not lower or higher than the lowest RB or RE index of the control information of PRS in frequency domain, the lowest RB or RE index of the transmission or the reception of one or more PRS is not lower or higher than the lowest RB or RE index of the control information of data in frequency domain, or the lowest RB or RE index of the transmission or the reception of one or more PRS is not lower or higher than the lowest RB or RE index of the control information of PRS in frequency domain.

In some embodiments, the configuration comprises at least one of a resource pool, a carrier frequency, a bandwidth part (BWP), a RB set or a subchannel. In some embodiments, the parameter is associated with an end of the second time window that includes a transmission or reception of one or more PRS satisfies at least one of: the parameter that is associated with an end of the second time window is value, the parameter that is associated with an end of the second time window is not related to PRS priority, the parameter that is associated with an end of the second time window is related to PRS priority, the parameter that is associated with an end of the second time window is related to response time a response time containing early location measurements or an early location estimate, the parameter that is associated with an end of the second time window is smaller or larger than response time a response time containing early location measurements or an early location estimate, the parameter that is associated with an end of the second time window is related to packet delay budget, or the parameter that is associated with an end of the second time window is before or after the parameter that is associated with an end of the second time window in time domain. In some embodiments, the parameter associated with a start or end of the first time window, or the parameter associated with a start or end of the second time window of the PRS satisfies at least one of: the parameter that is associated with the start of the first time window of the PRS is before or after the parameter that is associated with the start of the sensing window of the data, the parameter that is associated with the end of the first time window of the PRS is before or after the parameter that is associated with the end of the sensing of the data, the parameter that is associated with the start of the second time window of the PRS is before or after the parameter that is associated with the start of the selection window of the data, the parameter that is associated with the end of the second time window of the PRS is before or after the parameter that is associated with the end of the selection window of the data, an offset between the parameter that is associated with the start of the first time window of the PRS and the parameter that is associated with the start of the sensing window of the data, an offset between the parameter that is associated with the end of the first time window of the PRS and the parameter that is associated with the end of the sensing of the data, an offset between the parameter that is associated with the start of the second time window of the PRS and the parameter that is associated with the start of the selection window of the data, an offset between the parameter that is associated with the end of the second time window of the PRS and the parameter that is associated with the end of the selection window of the data, the parameter that is associated with the start of the first time window of the PRS is N time or N times of the parameter that is associated with the start of the sensing window of the data, the parameter that is associated with the end of the first time window of the PRS is N time or N times of the parameter that is associated with the end of the sensing of the data, the parameter that is associated with the start of the second time window of the PRS is N time or N times of the parameter that is associated with the start of the selection window of the data, the parameter that is associated with the end of the second time window of the PRS is N time or N times of the parameter that is associated with an end of the selection window of the data, or the parameter that is associated with the counter for resource reselection of the PRS is N time or N times of the parameter that is associated with the counter for resource reselection of the data, where N is a positive integer.

In some embodiments, the set of information includes one or more allowed synchronization references which are allowed to use the configured resource is associated with at least one of: a parameter in associated with data configuration, a parameter associated with a PRS configuration. In some embodiments, the set of information includes whether a reference signal of a channel is used for RSRP measurement that comprises at least one of: a reference signal of PSSCH, a reference signal of PSCCH, a reference signal which is associated with the PRS information. In some embodiments, the wireless communication device comprises a user equipment (UE), a network node, a base station, a local sever, a Transmission Reception Point (TRP), or a Location Management Function (LMF) device. In some embodiments, the gap is associated with UE capability. In some embodiments, the control information of data comprises a parameter which indicates whether a PRS configuration is active or deactivate.

In some embodiments, the PRS information does not comprise muting pattern information in operation with shared spectrum channel access. In some embodiments, the set of information and one or more parameters of data is independent, or the set of information and one or more parameters of data is configured or pre-configured. In some embodiments, a relationship of the certain time duration in a configuration or a first slot the certain time duration in the configuration in the set of information and one or more parameters of data is one of: the same, the certain time duration in a configuration or a first slot the certain time duration in the configuration in the set of information is before or after the certain time duration in a configuration or a first slot the certain time duration in the configuration in one or more parameters of data, or the certain time duration in a configuration or a first slot the certain time duration in the configuration in the set of information is not before or after the certain time duration in a configuration or a first slot the certain time duration in the configuration in one or more parameters of data. In some embodiments, the first time window includes a sensing window, and/or the second time window includes a selection window.

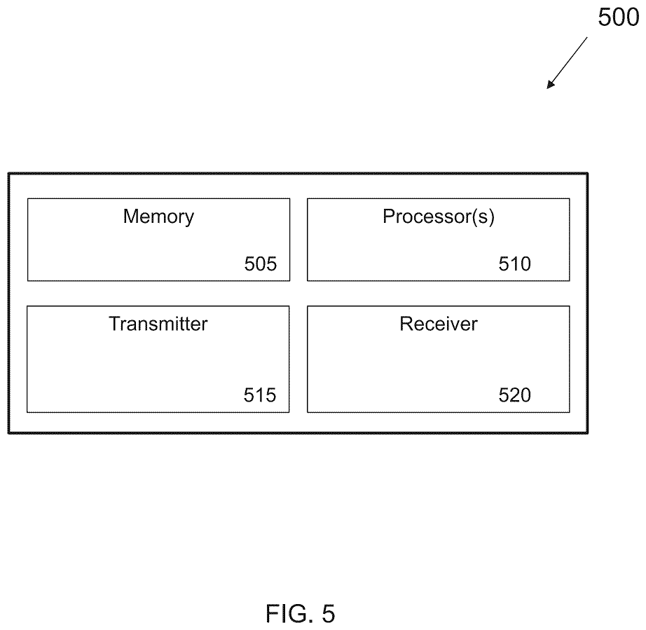

FIG. 5 shows an exemplary block diagram of a hardware platform 500 that may be a part of a network device (e.g., base station) or a communication device (e.g., a user equipment (UE)). The hardware platform 500 includes at least one processor 510 and a memory 505 having instructions stored thereupon. The instructions upon execution by the processor 510 configure the hardware platform 500 to perform the various embodiments described in this patent document. The transmitter 515 transmits or sends information or data to another device. For example, a network device transmitter can send a message to a user equipment. The receiver 520 receives information or data transmitted or sent by another device. For example, a user equipment can receive a message from a network device.

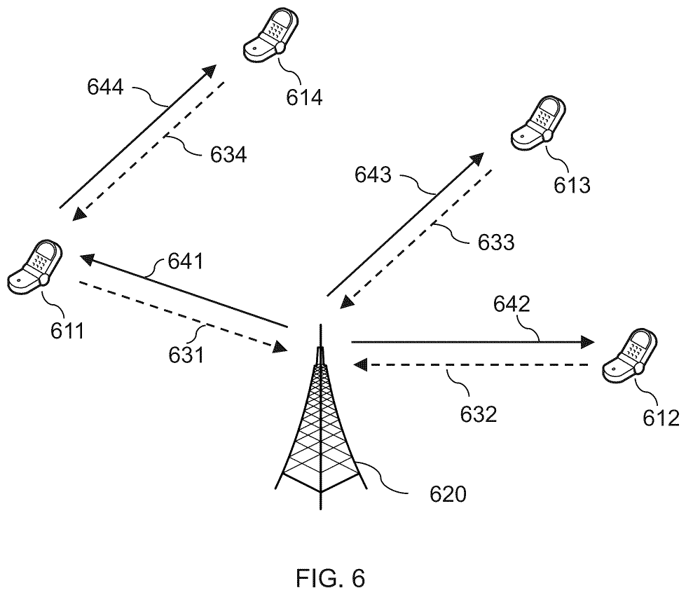

The implementations as discussed above will apply to a wireless communication. FIG. 6 shows an example of a wireless communication system (e.g., a 5G or NR cellular network) that includes a base station 620 and one or more user equipment (UE) 611, 612 and 613. In some embodiments, the UEs access the BS (e.g., the network) using a communication link to the network (sometimes called uplink direction, as depicted by dashed arrows 631, 632, 633), which then enables subsequent communication (e.g., shown in the direction from the network to the UEs, sometimes called downlink direction, shown by arrows 641, 642, 643) from the BS to the UEs. In some embodiments, the BS send information to the UEs (sometimes called downlink direction, as depicted by arrows 641, 642, 643), which then enables subsequent communication (e.g., shown in the direction from the UEs to the BS, sometimes called uplink direction, shown by dashed arrows 631, 632, 633) from the UEs to the BS. The UE may be, for example, a smartphone, a tablet, a mobile computer, a machine to machine (M2M) device, an Internet of Things (IoT) device, and so on. A sidelink or a device-to-device communication can be performed between two UEs 611 and 614, where information (e.g., control information) or signals (e.g., PRS) can be transmitted and received (shown as 644 and 634) between the two UEs 611 and 614.

The implementations as discussed above will apply to a wireless communication. FIGS. 7A-7D shows an example of where the control information of PRS can be informed. In some embodiments, the control information of data/PRS is only associated with one or more PRS communicated configurations/subchannels. In some embodiments, the control information of data/PRS and one or more PRS communicated in same configurations/subchannels. In some embodiments, the control information of data/PRS and one or more PRS can not communicated in same configurations/subchannels. In some embodiments, the control information of data/PRS is and the associated with one or more PRS can not communicated in different configurations/subchannels. For FIG. 7A, the control information of PRS can only inform that data subchannel1 and data subchannel2. For FIG. 7B, the control information of PRS can only inform that data subchannel1. For FIG. 7C, the control information of PRS can only inform that data subchannel2. For FIG. 7C, the control information of PRS can not inform in data subchannel1 and subchannel2.

The implementations as discussed above will apply to a wireless communication. FIGS. 8A-8D shows an example of where the PRS can be communicated. In some embodiments, the transmission of PRS can be transmitted in available RB set and gap. In some embodiments, the transmission of PRS can only be transmitted in available RB set. In some embodiments, the transmission of PRS can be transmitted in gap. In some embodiments, the transmission of PRS can not be transmitted in gap. In some embodiments, the transmission of one PRS can only be transmitted in one available RB set. For FIG. 8A, the transmission of PRS can be transmitted in RB set1, RB set2 and gap. For FIG. 8B, the transmission of PRS can not be transmitted in gap. For FIG. 8C, the transmission of PRS can be transmitted in RB set1. For FIG. 8D, the transmission of PRS1 can be transmitted in RB set1; the transmission of PRS2 can be transmitted in RB set2.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements and variations can be made based on what is described and illustrated in this disclosure.

What is claimed is:

1. A wireless communication method, comprising:
receiving, by a first wireless communication device from a second wireless communication device, a sidelink control information (SCI), wherein the SCI includes at least one of: a configuration of time domain resources or a time duration of a positioning reference signal (PRS); and
transmitting, by the first wireless communication device, a PRS information in response to receiving the SCI.

2. The wireless communication method of claim 1, wherein the first wireless communication device transmits the PRS information to the second wireless communication device or to a third wireless communication device through a fourth wireless communication device.

3. The wireless communication method of claim 1, wherein the SCI indicates a time window in which the PRS is transmitted or received by the first wireless communication device.

4. The wireless communication method of claim 1, wherein the PRS information comprises the time duration for the PRS.

5. The wireless communication method of claim 1, wherein the PRS information comprises a channel access priority.

6. The wireless communication method of claim 5, wherein the channel access priority is determined according to (i) a rule that specifies that a channel access priority class for a synchronization signal block (SSB) communicated by the first wireless communication device is set to a smallest channel access priority class value, or (ii) a rule that specifies that the channel access priority class is associated with a transmission of a physical sidelink feedback channel (PSFCH).

7. The wireless communication method of claim 1, wherein the SCI is associated with one or more occasions for one or more PRSs, the PRS information, or one or more PRS configurations.

8. The wireless communication method of claim 7, wherein the one or more PRS configurations comprises at least one of a standalone resource pool, a carrier frequency, a bandwidth part (BWP), an RB set, or a subchannel.

9. The wireless communication method of claim 1, wherein the PRS is not transmitted in a gap between two adjacent resource block (RB) sets in a frequency domain.

10. The wireless communication method of claim 9, wherein the gap is associated with UE capability, or the gap is equal to zero.

11. The wireless communication method of claim 1, wherein a lowest RB or resource element (RE) index of the PRS is aligned or associated with at least one of: a start of each RB set, a start of all RB sets, or a start of one certain RB set.

12. The wireless communication method of claim 1, wherein the SCI comprises a parameter which indicates whether a PRS configuration is active or not active.

13. The wireless communication method of claim 1, wherein the PRS information does not comprise muting pattern information in operation with shared spectrum channel access.

14. The wireless communication method of claim 1, further comprising:
selecting a transmission resource for the PRS from the configuration of time domain resources included in the SCI.

15. An apparatus for wireless communication, comprising:
a processor; and
a memory storing instructions that, when executed by the processor, cause the apparatus to:
receive, from a second wireless communication device, a sidelink control information (SCI), wherein the SCI includes at least one of: a configuration of time domain resources or a time duration of a positioning reference signal (PRS); and
transmitting a PRS information in response to receiving the SCI.

16. The apparatus of claim 15, wherein the PRS information is transmitted to the second wireless communication device or to a third wireless communication device through a fourth wireless communication device.

17. The apparatus of claim 15, wherein the PRS information comprises a PRS priority that is a channel access priority.

18. The apparatus of claim 17, wherein the channel access priority is determined according to (i) a rule that specifies that a channel access priority class for a synchronization signal block (SSB) is set to a smallest channel access priority class value, or (ii) a rule that specifies that the channel access priority class is associated with a transmission of a physical sidelink feedback channel (PSFCH).

19. The apparatus of claim 15, wherein the SCI comprises a parameter which indicates whether a PRS configuration is active or not active.

20. A non-transitory computer-readable storage medium having code stored thereon, the code, when executed by a processor, causing the processor to implement a method comprising:
receiving, by a first wireless communication device from a second wireless communication device, a sidelink control information (SCI), wherein the SCI includes at least one of: a configuration of time domain resources or a time duration of a positioning reference signal (PRS); and
transmitting, by the first wireless communication device, a PRS information based on the SCI.
